(19) United States
(12) Patent Application Publication
(10) Pub. No.: US 2025/0068695 A1
(43) Pub. Date: Feb. 27, 2025

(54) MULTI-TABLE APPROACH TO FLOATING-POINT FUNCTION APPROXIMATION

(71) Applicant: INTERNATIONAL BUSINESS MACHINES CORPORATION, ARMONK, NY (US)

(72) Inventors: ROBERT FREDERICK ENENKEL, MARKHAM (CA); CHRISTOPHER ANAND, DUNDAS (CA); SILVIA MELITTA MUELLER, ST. INGBERT (DE); LUCAS DUTTON, HAMILTON (CA); YU-SHIUAN WU, NEWMARKET (CA)

(21) Appl. No.: 18/455,247

(22) Filed: Aug. 24, 2023

(51) Int. Cl. G06F 17/17; G06F 1/03; G06F 7/483

(52) U.S. Cl. CPC G06F 17/17; G06F 1/03; G06F 7/483

(57) ABSTRACT

Function approximation includes receiving a number value to be input to a function. The number value includes a first and second plurality of bits. A first approximation value of a function is determined using the first plurality of bits as an index to a first lookup table including a plurality of candidate first approximation values. A first correction coefficient is determined using the first plurality of bits as an index to a second lookup table including a plurality of candidate first correction coefficients. A second correction coefficient is determined by using the first plurality of bits as an index to a third lookup table including a plurality of candidate second correction coefficients. A second approximation value of the function is determined based on the first approximation value, the first correction coefficient, and the second plurality of bits.

### BACKGROUND

### Field of the Disclosure

The field of the disclosure is data processing, or, more specifically, methods, apparatus, and products for a multi-table approach to floating-point function approximation.

### Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

The performance of data processing applications such as artificial intelligence (AI), analytics, and databases often depends upon a small number of important mathematical functions used for computation. For AI applications, linear operations are important and are often performed using specialized hardware accelerators. As a result, non-linear functions are often dominant in terms of execution time of algorithms, including basic arithmetic functions (e.g., divide) and specialized functions (e.g., activation functions such as sigmoid). One common problem for implementation of standard functions is balancing performance and precision. AI applications are typically very sensitive to performance but tolerate lower precision. Other applications using the same functions may be very sensitive to accuracy. In integrated system designs, arithmetic engines often share components necessitating meeting both requirements with the same hardware.

### SUMMARY

Apparatus and systems for function approximation include receiving a number value to be input to a function. The number value includes a first plurality of bits and a second plurality of bits. The method includes determining a first approximation value of a function by using the first plurality of bits as an index to a first lookup table including a plurality of candidate first approximation values; determining a first correction coefficient by using the first plurality of bits as an index to a second lookup table including a plurality of candidate first correction coefficients; and determining a second correction coefficient by using the first plurality of bits as an index to a third lookup table including a plurality of candidate second correction coefficients. The method further includes determining a second approximation value of the function based on the first approximation value, the first correction coefficient, and the second plurality of bits.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 is a block diagram of automated computing machinery comprising an exemplary computing system configured for a multi-table approach to floating-point function approximation according to embodiments of the present disclosure.

FIG. 2 is an example of a fraction component of a floating-point number representation according to embodiments of the present disclosure.

FIG. 3 is a graph of an example approximated function of interest according to embodiments of the present disclosure.

FIG. 4 is a flowchart of an example method for floating-point function approximation according to some embodiments of the present disclosure.

FIG. 5A is a block diagram of an example hardware implementation for floating-point function approximation according to some embodiments of the present disclosure.

FIG. 5B is a diagram showing alignment of adder terms used by the example hardware of FIG. 5A.

FIG. 6 is a flowchart of another example method for function approximation according to some embodiments of the present disclosure.

### DETAILED DESCRIPTION

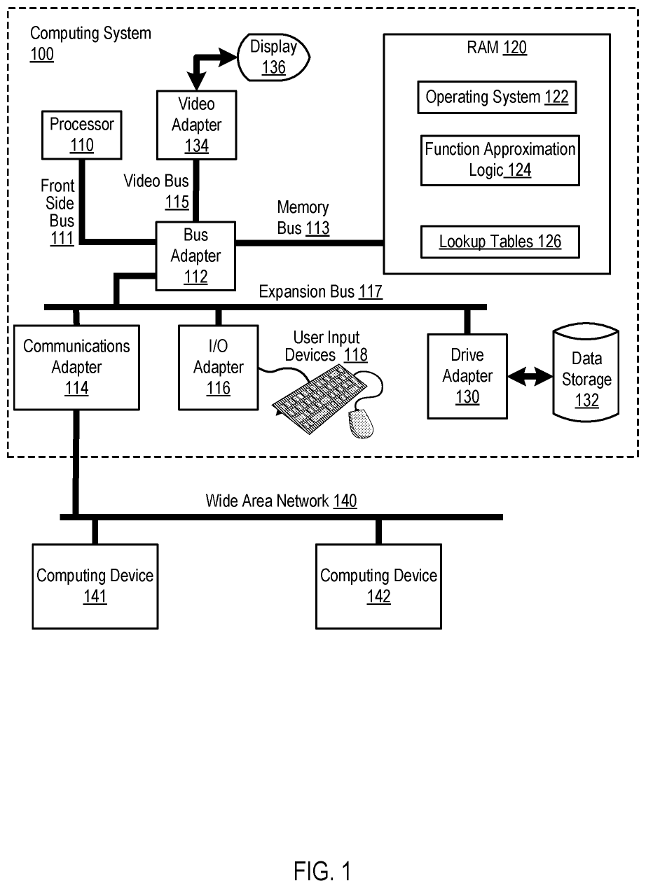

Exemplary apparatus and systems for a multi-table approach to floating-point function approximation in accordance with the present disclosure are described with reference to the accompanying drawings, beginning with FIG. 1. FIG. 1 sets forth a block diagram of automated computing machinery comprising an exemplary computing system 100 configured for a multi-table approach to floating-point function approximation according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for function approximation according to embodiments of the present disclosure include UNIX™, Linux™, Microsoft Windows™, AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is function approximation logic 124 useful for a multi-table approach to floating-point function approximation according to embodiments of the present disclosure. Floating-point numbers are used to represent non-integer fractional numbers. A floating-point number is expressed as the product of two parts, a fraction and a power of two. The fraction component represents the actual binary digits of the floating-point number and the power of two is represented by the exponent component. In particular embodiments, the function approximation logic 124 is configured to calculate an approximate value of a function when a floating-point number is provided as input to the function. Also stored in RAM are lookup tables 126 configured for storing approximation values and correction coefficients and utilized by the function approximation logic to perform floating-point function approximation according to embodiments of the present disclosure. In particular embodiments, the function approximation logic 124 may be utilized by applications such as AI, analytic, or database applications. Although the function approximation logic 124 and lookup tables 126 are shown in the embodiment of FIG. 1 as being located within RAM 120, in other embodiments one or more of the function approximation logic 124 and lookup tables 126 are implemented in hardware utilizing hardware logic such as logic gates. In other embodiments, the function approximation logic 124 and/or lookup tables 126 are embodied within a processor such as processor 110.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (‘I/O’) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

Existing processes for performing floating-point approximations to elementary functions typically include looking up a table of values followed by a series of corrections, performed in iterations, to refine the result. For existing approximation algorithms, the design of the table must be taken into consideration. Factors such as the size of the table, the width of the table (i.e., the bit length of the table values), and the interval of the table are design parameters that are chosen in conjunction with an associated series iteration to yield the required number of accurate bits. However, existing approximation algorithms are not fast enough, or if their table sizes are increased to compensate, the hardware footprint becomes too large. The main goal of the existing approximation methods is to provide an accurate approximation to elementary functions while reducing execution time and table size. In particular, the choices made to the design of the table have to balance between the size of the table that can feasibly be stored in memory, and the accuracy of the table, which would typically scale with an increasing table size. In addition, using series approximations increases execution time of the algorithm, and for single-precision or reduced-precision computation in particular may make an algorithm uncompetitive. With accurate tables, a design must deal with the table maker's dilemma, which states that there does not exist a general method to predict for an arbitrary function how much precision is required in intermediate results in order to correctly round to some preassigned number of digits.

Various embodiments described herein utilize the lookup tables 126 as a replacement to the correction step with the aim of reducing the execution time (e.g., in number of cycles) required to obtain a sufficiently accurate approximation to functions of interest in single-precision floating-point or higher precision floating-point applications. Various embodiments described herein do not rely on a series approximation after obtaining a value from the table lookup. Instead, various embodiments utilize three separate lookup tables to compute a final value of an elementary function. The first table is indexed by the most significant bits of the input fraction, and correspond to typical values of selected output values of the function. The next two tables serve as a linear and quadratic correction, respectively, and are also indexed by the most significant bits to obtain a linear correction coefficient and quadratic correction coefficient. The lower bits are used along with the linear and quadratic correction coefficients to calculate a linear correction and a quadratic correction, respectively. In various embodiments, the table values are then combined using reduced-width multiplication to yield the final approximation result. Due to the nature of the correction applied, the function in question should be continuous in the chosen interval, and should be well-approximated by its quadratic Taylor series. Fortunately, most elementary functions including sqrt, exp, and div possess these qualities and can implement this method.

The first table, referred to herein as the T-table, includes values from the function of interest in a predetermined interval. Given that the domain is that of binary floating-point numbers, an interval is chosen within one binade. A binade is a set of binary floating-point values that all have the same sign and exponent. In other words, a binade is the interval [2ⁿ, 2ⁿ⁺¹) from some integer value of n. In an example, an interval within one binade such as [0.5, 1), [1, 2). [2, 4), or a combination of two such adjacent intervals are chosen, depending upon the function of interest. In one or more embodiments, the values of the T-table are computed to have a few extra bits of precision over a target precision to aid in the computation of the next table.

The second table, referred to herein as the S-table, includes values of the difference between adjacent T-table values, i.e., S[i]=T[i+1]−T[i]. Because of the increased precision of the T-Table, cancellation errors in the subtraction are reduced and accuracy of the correction is improved. The S-table provides a linear correction coefficient that is used in the calculation of a linear correction to a T-table value.

The third table, referred to herein as the A-table, includes a small correction applied to the S-table value, and represents a quadratic approximation to the residual error of the function on the subinterval. An important property in each subinterval is the fact that the error value is the greatest near the middle of the subinterval, and monotonically decreases one either side. In some embodiments, the A-table is calculated by dividing the error at the midpoint by the product of the distance from both ends of the interval. From the A-table, the second correction value is obtained by multiplying the A-table value by the distance of the point to both ends of the interval, which is approximated as the product of the lower significant bits with their 1's complement.

In one or more embodiments, the accuracy of the three-table approach is further refined by adding a fixed correction to each value of one or more of the tables. The choice of correction depends on accuracy requirements, either a symmetric error set or one-sided errors. In either case, an exhaustive search may be performed on a fixed, discrete set of corrections in an interval (e.g., [−5, 5] units in the last place (ulp)) that is added to the table values of each subinterval. In particular embodiments, the correction is chosen to minimize or maintain a maximum absolute error on the subinterval, subject to the constraints of the requirements.

Although particular embodiments are described herein as using three lookup tables for performing function approximation, in other embodiments a different number of lookup tables are used.

Although various embodiments are directed to floating-point function approximation, in other embodiments the principles described herein can be adapted to calculate function approximations for fixed-point formats. In particular embodiments, the method excludes the handling of an exponent component in the calculations for integer and/or fixed-point function approximation. In another particular embodiment, for signed number representations, the method includes performing two's complement arithmetic during the calculations. In other embodiments, the method also adjusts bit-widths to suit fixed point functions such as integer division.

Embodiments of the approximation algorithm described herein provide for an advantage of increased speed of execution. While most common algorithms rely on a final polynomial evaluation to increase accuracy of the table lookup, embodiments described herein are able to perform the three table lookups in parallel and combine them. Most processor architectures support lookups in parallel, and polynomial evaluations are typically more computationally expensive as they involve fused multiply-add operations. Incorporating corrections as tables also serves to increase the accuracy of the result, which would otherwise be a point of concern if only tables are relied on to provide the result. In various embodiments, all three tables share the same size after optimizing the third table which reduces the memory requirements to store these tables. Accordingly, the method described in various embodiments is superior to just increasing the size of the first table which would be necessary in conventional methods in order to increase the accuracy of the result, as the number of values in the table would increase significantly. In various embodiments, the calculations are performed using simplified integer arithmetic.

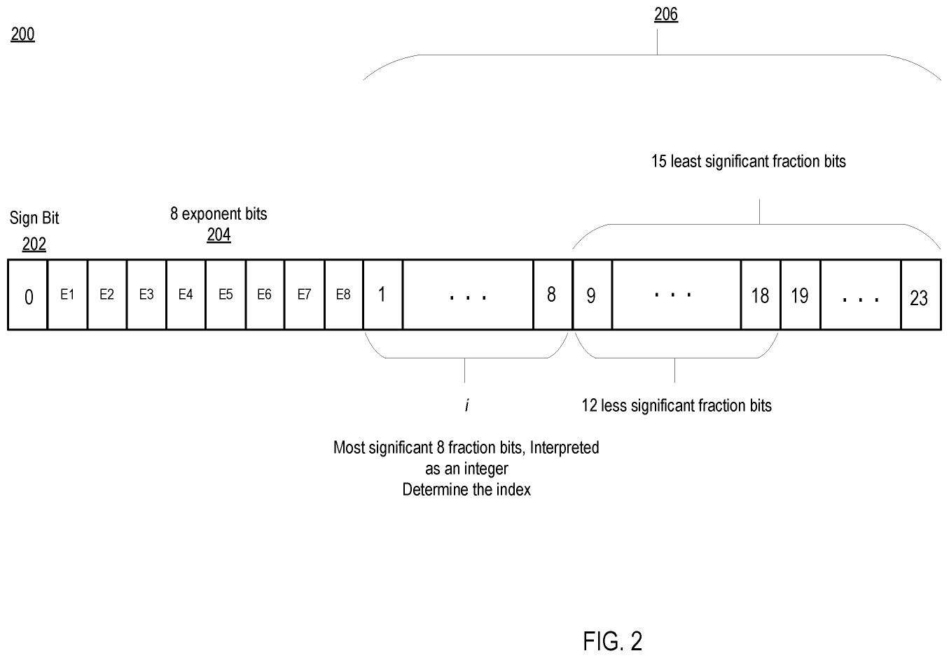

For further explanation, FIG. 2 is an example 200 of a fraction component of a floating-point number representation according to embodiments of the present disclosure. FIG. 2 sets forth an example of a sign bit 202, an exponent component 204 and a fraction component 206 of a floating-point number representation according to embodiments of the present disclosure. The sign bit 202 indicates whether the floating-point number is a positive or negative number with a “0” implying a positive number and a “1” implying a negative number. The exponent component 204 contains a biased integer power of two. In particular embodiments, the bits 1-8 of the fraction form an 8-bit bit field interpreted as an index i to search each of the three tables to determine a fixed-point value, a fixed-point linear correction coefficient, and a fixed-point quadratic correction coefficient as will be further described below. In an embodiment bits 9-23 of the fraction form a 15-bit bit field and are used along with the linear correction coefficient to calculate the linear correction of the function. In an embodiment, bits 9-20 of the fraction form a 12-bit bit field and are used along with the quadratic correction coefficient to calculate the quadratic correction of the function.

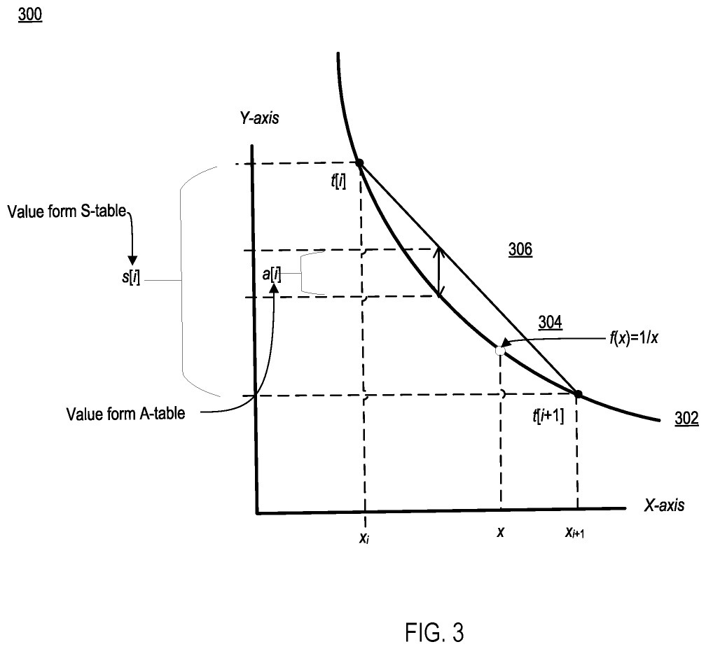

For further explanation, FIG. 3 sets forth a graph 300 of an example approximated function of interest according to embodiments of the present disclosure. The example function of interest is represented by a curve 302 and is equal to ƒ(x)=1/x. It is desired to approximate the function at some point x between xᵢ and xᵢ₊₁. The values xᵢ and xᵢ₊₁ are easy to calculate in the case that the value x is in the interval [1, 2), namely xᵢ=1+i/256 and xᵢ₊₁=1+(i+1)/256. The higher eight bits i of the fraction component 206 is used as an index to look up respective values from the T-table, S-table, and A-table from a number of candidate values stored in the table and are referred to as t, s, and a, respectively. Each of the candidate values is stored within the T-table, S-table, and A-table in association with a different index i. The value t corresponds to t[i] in the graph 300, and is an approximation to ƒ(xᵢ). To approximate ƒ(x), a linear approximation is formed by a line 304 with a slope given by s. The initial approximation t is improved by computing L=t−s*X (9:23) which effectively moves along the line 304 until x is reached. In the particular example, only the bits 9-23 of x that have not already been used to index the tables (i.e., bits 1-8) are used. It should be noted that the line 304 has some error as an approximation to the curve 302, which is greatest when x is approximately midway between xᵢ and xᵢ₊₁. The approximation is improved further by applying a quadratic correction based upon the value of a obtained from the A-table. This is performed by multiplying a by X(9:20)*(−X(9:20)) and subtracting the result from L Taking z=X(9:20)*(−X(9:20)), the quadratic correction Q is determined by Q=z*a. The final approximation y is obtained by y=L−Q. In the example of FIG. 3, using all of the bits of x is not necessary because the squaring operation makes the contribution of the low bits small enough to be irrelevant. In the particular example, using only bits 9-20 of x is sufficient. This quadratic correction is shown as the line 306 with arrows extending from the line 306 to the curve 302. The result is the approximation to the function of interest ƒ(x).

Although the example of FIG. 3 is described as using a specific number of bits (e.g., X(9:23)), in other embodiments different choices of how the floating-point bits are utilized is determined to suit different tables sizes appropriate for different functions, floating-point formats, and accuracy levels.

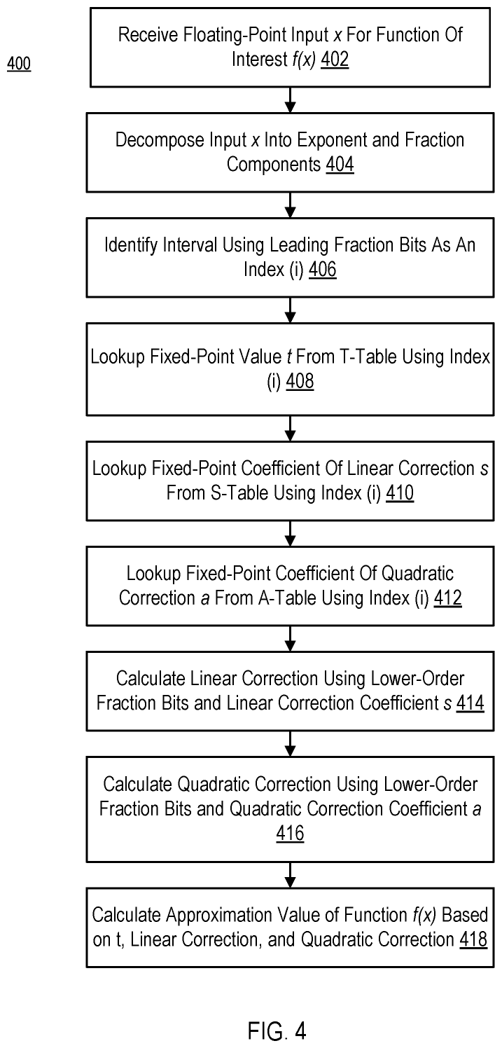

For further explanation, FIG. 4 is a flowchart of an example method 400 for floating-point function approximation according to some embodiments of the present disclosure. The method 400 includes receiving 402 a floating point input x for a function of interest ƒ(x). The function of interest ƒ(x) may include a number of different mathematical functions (e.g., reciprocal, divide, square root, reciprocal square root, exponential, log, trigonometric, libm functions, sigmoid). In some embodiments, different mathematical functions are approximated via different tables. The input x is decomposed 404 into a sign bit, an exponent component and a fraction component. In some embodiments, subnormal inputs are converted to normal floating-point form, in which the fraction can be interpreted as fractional bits. An interval of the function is identified 406 using leading fraction bits as an index (i). In a particular embodiment, leading fraction bits forming the index (i) includes bits 1-8 of the binary fraction of the input x. A lookup 408 is performed in the T-table using the index (i) to determine a fixed-point value t corresponding to the index (i) from among a number of candidate t-values in the T-table. The value t is a first approximation of the function ƒ(x) evaluated for the input x. A lookup 410 is performed in the S-table using the index (i) to determine a fixed-point value s corresponding to the index (i) from among a number of candidate s-values in the s-table. The value s is a linear correction coefficient to be used in a calculation to determine a linear correction to be applied to the value t. A lookup 412 is performed in the A-table using the index (i) to determine a fixed-point value a corresponding to the index (i) from among a number of candidate a-values in the A-table. The value a is a quadratic correction coefficient to be used in a calculation to determine a quadratic correction to be applied to the linear approximation, calculated using the t value and the s value. In a particular embodiment, the lookup 408, the lookup 410, and the lookup 412 are performed substantially in parallel.

A linear correction is calculated 414 using lower-order fraction bits of the input x and the linear correction coefficient. In a particular embodiment, the lower order fraction bits of the input x used to calculate the linear correction include bits 9-23 of the fraction. A quadratic correction is calculated 416 using lower-order fraction bits of the input x and the quadratic correction coefficient. A second approximation value y of the function ƒ(x) is calculated 418 based on the value t, the linear correction and the quadratic correction. In one or more embodiments, the final approximation of the function ƒ(x) evaluated at the input x is determined by creating the resultant sign and exponent components (using standard techniques known by those skilled in the art) and combining it with the fraction components of the second approximation value y to form a floating-point number.

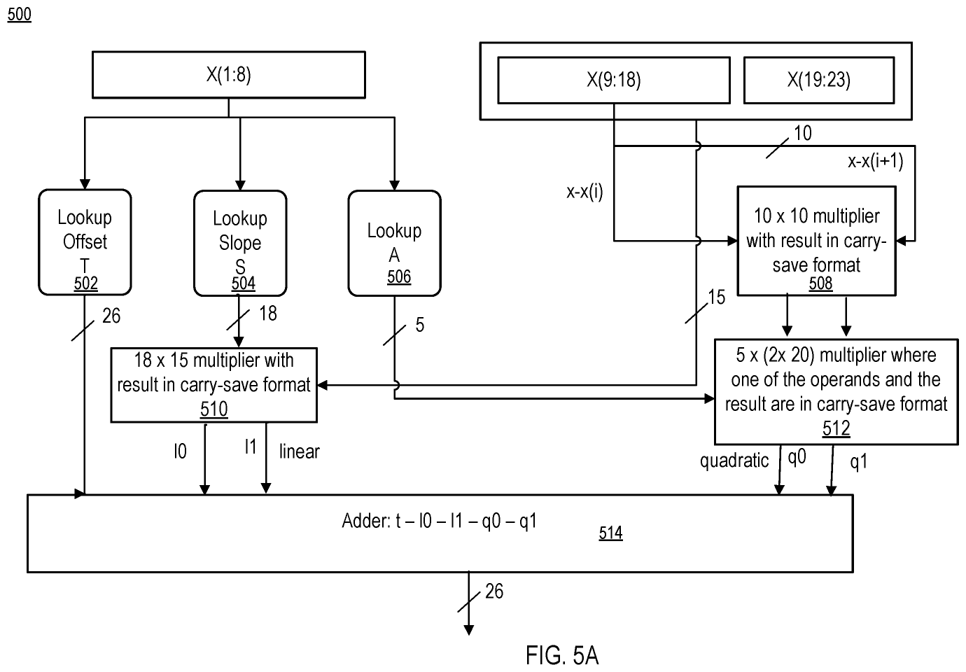

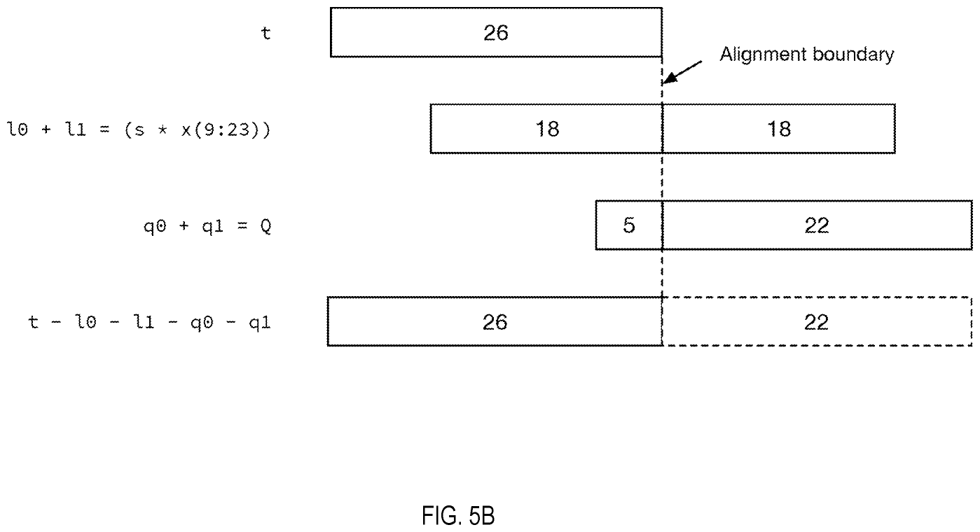

For further explanation, FIG. 5A is a block diagram of an example hardware implementation 500 for floating-point function approximation according to some embodiments of the present disclosure. In a particular embodiment, the hardware implementation 500 is embodied in a processor of a computing system such as processor 110 of FIG. 1. The leading significand bits 1-8 (X(1:8)) of a fraction of a floating-point input is used as an index to lookup an offset value t within a lookup table T 502, a slope value s (i.e., linear correction coefficient) within a lookup table S 504, and a value a (i.e., quadratic correction coefficient) within a lookup table A 506 represented as follows:
t=T[X(1:8)]
s=S[X(1:8)]
a=A[X(1:8)]

The fraction X is itself a 23-bit fixed-point number. In a particular embodiment, the value t is 26 bits, the value s is 18 bits, and the value a is 5 bits. In a particular embodiment, the T-table contains 256 values, each 26-bit wide, the S-table contains 256 values, each 18-bit wide, and the A-table contains 256 values, each 5-bit wide.

Bits 9-20 (12 bits) of x(x(9:20) are provided to multiplication block 508 which functions to multiply X(9:20)*(−X(9:20)) to effectively calculate the product of (x−xᵢ) and (x−xᵢ₊₁). In particular embodiments, the term (x−xᵢ₊₁) is computed by taking the one's complement of (x−xᵢ). In particular embodiments, the multiplication block 508 may utilize Booth's algorithm to multiply X(9:20)*(−X(9:20)) represented by z=X(9:20)*(−X(9:20)). The multiplication block 508 further provides the product as two vectors in a carry-save format. Each vector is at most 20-bit wide. In one or more embodiments, the lookup operation of the T-table, the S-table, and the A-table, and the multiplication by multiplication block 508 are performed in parallel within approximately one cycle.

The 18 bits of the linear correction coefficient value s and bits X(9:23) (15 bits) are provided to a multiplication block 510. In one or more embodiments, the multiplication block 510 performs the multiplication of s and X(9:23), producing the result in carry-save format, l0 and l1. The subtraction of t minus the product, producing the linear correction term L, is delayed to the adder block 514.

$$10 + 11 = s * X ( 9 : 23 ) \\ L = t - s * X ( 9 : 23 )$$

The quadratic correction coefficient value a (5 bits) and the two output vectors of the multiplication block 508 are provided to a multiplication block 512. In one or more embodiments, the multiplication block 512 is capable of accepting one of its operands in carry-save format. The multiplication block 512 calculates a quadratic correction Q and represents the product in carry-save format as follows:

$$\begin{matrix}Q = z * a \\ = q 0 + q 1\end{matrix}$$

In a particular embodiment, the calculation of the linear correction L and the quadratic correction Q are performed substantially in parallel.

The linear correction L and the quadratic correction Q are provided to an approximation calculation block 514. The approximation calculation block 514 determines an approximated value of the function y using an adder as follows:

$$\begin{matrix}y = L - Q \\ = t - 10 - 11 - q 0 - q 1\end{matrix}$$

In a particular embodiment, the approximation calculation block 514 calculates the approximated value of the function y. To produce a final approximated value the sign bit and exponent component are calculated separately and rejoined with the result y. FIG. 5B is a diagram showing alignment of adder terms used by the example hardware of FIG. 5A FIG. 5B describes the relationship between the place values t, l0+l1, q0+q1.

In various embodiments, additional corrections may be applied to the output y to increase precision of the approximation such as using a polynomial approximation (e.g., a Taylor series or other series depending upon the function of interest). In various embodiments, a final rounding step is performed to produce a rounded final answer.

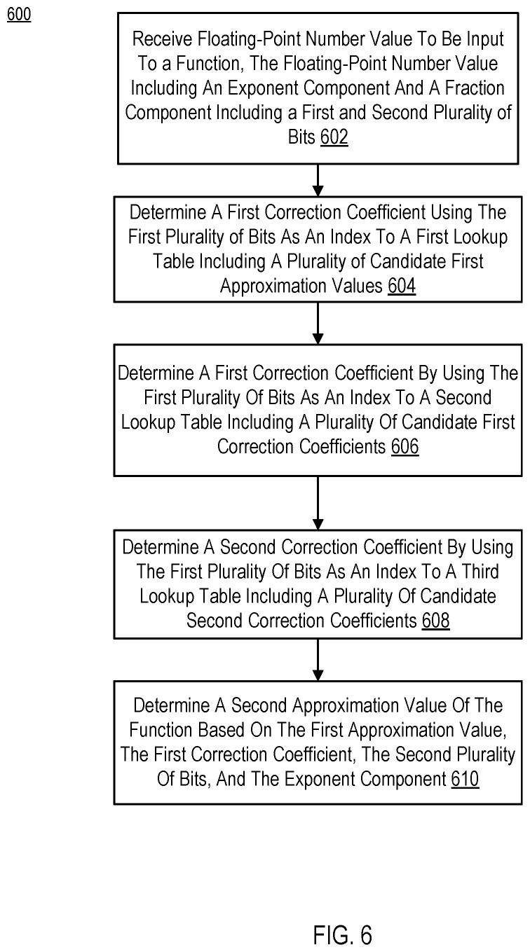

For further explanation, FIG. 6 is a flowchart of another example method for function approximation according to some embodiments of the present disclosure. In the method 600, a number value to be input to a function is received 602. The number value includes a first plurality of bits and a second plurality of bits. In a particular embodiment, the function comprises a non-linear function.

The method 600 includes determining 604 a first approximation value of a function by using the first plurality of bits as an index to a first lookup table including a plurality of candidate first approximation values. In a particular embodiment, the plurality of candidate first approximation values of the first lookup table includes values of the function in a predetermined interval.

The method 600 further includes determining 606 a first correction coefficient by using the first plurality of bits as an index to a second lookup table including a plurality of candidate first correction coefficients. In a particular embodiment, the first correction coefficient is a linear correction coefficient. In a particular embodiment, the plurality of candidate first correction coefficients of the second lookup table include a difference between adjacent first approximation values of the first lookup table.

The method 600 further includes determining 608 a second correction coefficient by using the first plurality of bits as an index to a third lookup table including a plurality of candidate second correction coefficients. In a particular embodiment, the second correction coefficient is a quadratic correction coefficient. In a particular embodiment, the first approximation value, the first correction coefficient, and the second correction coefficient comprise fixed-point values.

The method 600 further includes determining 610 a second approximation value of the function based on the first approximation value, the first correction coefficient, and the second plurality of bits. In a particular embodiment, determining the second approximation value of the function further includes determining a linear approximation based on the first approximation value, the first correction coefficient, and the second plurality of bits.

In an embodiment, the number value is a floating-point number value. In another embodiment, the floating-point number value comprises a sign bit, an exponent component and a fraction component, and the fraction component comprises the first plurality of bits and the second plurality of bits. In another embodiment, determining the second approximation value is further based on the exponent component. In another particular embodiment, the number value is an integer number value. In an embodiment, each of the first approximation value, the first correction coefficient, and the second correction coefficient comprise fixed-point values.

In an embodiment, determining the second approximation value of the function further comprises determining a linear approximation based on the first approximation value, the first correction coefficient, and the second plurality of bits. In an embodiment, the linear approximation is determined by subtracting a product of the first correction coefficient and the second plurality of bits from the first approximation value. In an embodiment, determining the second approximation value of the function further comprises determining a quadratic approximation based on the second plurality of bits and the second correction coefficient. In an embodiment, determining the second approximation value of the function further comprises determining the second approximation value of the function based on subtraction of the quadratic approximation from the linear approximation.

In an embodiment, determining the first approximation value, the first correction coefficient, and the second correction coefficient are performed substantially in parallel. In an embodiment, the plurality of candidate first approximation values of the first lookup table includes values of the function in a predetermined interval.

In an embodiment, the plurality of candidate first correction coefficients of the second lookup table include a difference between adjacent first approximation values of the first lookup table. In an embodiment, the first plurality of bits includes higher-order fraction bits, and the second plurality of bits includes lower-order fraction bits.

In view of the explanations set forth above, readers will recognize that the benefits of a multi-table approach to floating-point function approximation according to embodiments of the present disclosure include:
Increased speed of execution of function evaluations.
Implementable using parallel circuits in existing architectures.
Correction calculations may be performed independently of one another.
Fixed-point calculations can be optimized to low bit widths.
Many arithmetic calculations are replaced by extraction of and operations on bit fields.
Can be applied to many mathematical functions.

Exemplary embodiments of the present disclosure are described largely in the context of a fully functional computer system for a multi-table approach to floating-point function approximation. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method for function approximation, the method comprising:
receiving a number value to be input to a function, the number value including a first plurality of bits and a second plurality of bits;
determining a first approximation value of a function by using the first plurality of bits as an index to a first lookup table including a plurality of candidate first approximation values;
determining a first correction coefficient by using the first plurality of bits as an index to a second lookup table including a plurality of candidate first correction coefficients;
determining a second correction coefficient by using the first plurality of bits as an index to a third lookup table including a plurality of candidate second correction coefficients; and
determining a second approximation value of the function based on the first approximation value, the first correction coefficient, and the second plurality of bits.

2. The method of claim 1, wherein the number value is a floating-point number value.

3. The method of claim 2, wherein the floating-point number value comprises a sign bit, an exponent component and a fraction component, wherein the fraction component comprises the first plurality of bits and the second plurality of bits.

4. The method of claim 3, wherein determining the second approximation value is further based on the exponent component.

5. The method of claim 1, wherein the number value is an integer number value.

6. The method of claim 1, wherein each of the first approximation value, the first correction coefficient, and the second correction coefficient comprise fixed-point values.

7. The method of claim 1, wherein the first correction coefficient is a linear correction coefficient.

8. The method of claim 1, wherein the second correction coefficient is a quadratic correction coefficient.

9. The method of claim 1, wherein determining the second approximation value of the function further comprises determining a linear approximation based on the first approximation value, the first correction coefficient, and the second plurality of bits.

10. The method of claim 9, wherein the linear approximation is determined by subtracting a product of the first correction coefficient and the second plurality of bits from the first approximation value.

11. The method of claim 10, wherein determining the second approximation value of the function further comprises determining a quadratic approximation based on the second plurality of bits and the second correction coefficient.

12. The method of claim 11, wherein determining the second approximation value of the function further comprises determining the second approximation value of the function based on subtraction of the quadratic approximation from the linear approximation.

13. The method of claim 1, wherein determining the first approximation value, the first correction coefficient, and the second correction coefficient are performed substantially in parallel.

14. The method of claim 1, wherein the plurality of candidate first approximation values of the first lookup table includes values of the function in a predetermined interval.

15. The method of claim 1, wherein the plurality of candidate first correction coefficients of the second lookup table include a difference between adjacent first approximation values of the first lookup table.

16. The method of claim 1, wherein the first plurality of bits includes higher-order fraction bits, and the second plurality of bits includes lower-order fraction bits.

17. The method of claim 1, wherein the function comprises a non-linear function.

18. An apparatus for function approximation, the apparatus comprising:
a processor; a computer memory operatively coupled to the processor; and
logic configured to cause the apparatus to:
receive a number value to be input to a function, the number value including a first plurality of bits and a second plurality of bits;
determine a first approximation value of a function by using the first plurality of bits as an index to a first lookup table including a plurality of candidate first approximation values;
determine a first correction coefficient by using the first plurality of bits as an index to a second lookup table including a plurality of candidate first correction coefficients;
determine a second correction coefficient by using the first plurality of bits as an index to a third lookup table including a plurality of candidate second correction coefficients; and
determine a second approximation value of the function based on the first approximation value, the first correction coefficient, and the second plurality of bits.

19. The apparatus of claim 18, wherein the first correction coefficient is a linear correction coefficient.

20. The apparatus of claim 18, wherein the second correction coefficient is a quadratic correction coefficient.

21. The apparatus of claim 18, wherein determining the second approximation value of the function further comprises determining a linear approximation based on the first approximation value, the first correction coefficient, and the second plurality of bits.

22. The apparatus of claim 18, wherein determining the second approximation value of the function further comprises determining a quadratic approximation based on the second plurality of bits and the second correction coefficient.

23. The apparatus of claim 18, wherein the first plurality of bits includes higher-order fraction bits, and the second plurality of bits includes lower-order fraction bits.

24. A computer program product for function approximation, the computer program product disposed upon a computer readable medium, the computer program product comprising computer program instructions that, when executed, cause a computer to:
receive a number value to be input to a function, the number value including a first plurality of bits and a second plurality of bits;
determine a first approximation value of a function by using the first plurality of bits as an index to a first lookup table including a plurality of candidate first approximation values;
determine a first correction coefficient by using the first plurality of bits as an index to a second lookup table including a plurality of candidate first correction coefficients;
determine a second correction coefficient by using the first plurality of bits as an index to a third lookup table including a plurality of candidate second correction coefficients; and
determine a second approximation value of the function based on the first approximation value, the first correction coefficient, and the second plurality of bits.
